(19) United States
(12) Patent Application Publication
(10) Pub. No.: US 2018/0200837 A1
(43) Pub. Date: Jul. 19, 2018

(54) METHOD OF PREPARING A SHEET-METAL WORKPIECE FOR COATING

(71) Applicant: GEDIA Gebrueder Dingerkus GmbH, Attendorn (DE)

(72) Inventors: Andreas BOEHMER, Lennestadt (DE); Michael DOHLE, Schmallenberg (DE); Josef STRAUTZ, Attendorn (DE)

(21) Appl. No.: 15/863,228

(22) Filed: Jan. 5, 2018

(30) Foreign Application Priority Data
Jan. 19, 2017 (DE) 102017100961.2

(51) Int. Cl. B23K 26/361; B21D 28/02; B23K 26/0622; B23K 26/352; C25D 13/04; C25D 13/20

(52) U.S. Cl. CPC B23K 26/361; B21D 28/02; C25D 13/20; B23K 26/352; C25D 13/04; B23K 26/0622

(57) ABSTRACT

A sheet-metal workpiece is prepared for coating by first trimming or punching a sheet-metal workpiece to give it an edge with sharp corners. Then the edge is rounded such that the corners are no longer sharp and merge into adjacent faces of the workpiece. Finally, and coating at least the rounded edge of the workpiece with an anticorrosive agent with a matrix of organic binders or with predominantly organic components.

### FIELD OF THE INVENTION

The invention relates to a method of preparing a sheet-metal workpiece having a cut edge, particularly peripherally and/or in the vicinity of punched holes, punch-outs, or similar material cutouts, for coating with an anticorrosive agent with a matrix of organic binders or with predominantly organic components, particularly through cathodic electrodeposition.

### BACKGROUND OF THE INVENTION

It is known in the prior art to form or structure sheet-metal workpieces so as to be appropriately dimensionally stable through punching or similar processing.

Such sheet-metal workpieces can also have punched-out or laser-cut holes or the like through which fasteners or the like can be inserted.

In order to protect such a sheet-metal workpiece against corrosion, it is coated with an anticorrosive agent that contains a matrix of organic binders or with predominantly organic components. For example, it is common to provide such workpieces with an anodic or cathodic E-coating.

Here, cathodic E-coating means electrophoretic cathode metal coating. Anodic E-coating is electrophoretic anode metal coating. What is essential here above all is the protection of the edges of the corresponding sheet-metal workpiece, since it is at the edges that signs of corrosion are most likely to appear, namely as a result of a faulty or excessively thin coating there.

Such coatings with organic binders or the like are used above all because they have good paintability, so they can be advantageously used and processed in automotive engineering.

For example, such a cathodic E-coating is processed further after it is applied. More particularly, the coated sheet-metal workpiece is reheated in a suitable heating furnace to about 180 to 190° C., so that the coating liquefies partially and a chemical crosslinking of the components of the coating is brought about.

Workpieces that are coated with such thermally cross-linked coatings suffer damage as finished workpieces during the production life cycle as a result of edge corrosion. The occurrence of corrosion is directly related to the coating thickness. If the coating thickness is too thin or non-existent, premature corrosion can be expected particularly near the edges, which is unwelcome. One possible cause for overly thin coating thicknesses on sheet-metal workpieces lies in the geometry of the trimmed edges. In a furnace heating process, the applied coating is liquefied. The molecular forces of the coating then attempt to keep the surface area of the coating as small as possible (surface tension). As a result, the coverage of the coating is less at a sharp edge of a sheet-metal workpiece than on the faces. This results in commensurate defects.

It has already been attempted to eliminate this defect by increasing the coating thickness at the edges. The mechanical processing of the edges for the purpose of mitigating this process is laborious and also practically impossible in the case of thin sheet-metal workpieces.

### OBJECT OF THE INVENTION

Taking this prior art as a point of departure, it is the object of the invention to provide a method of this generic type with which improved anticorrosive protection can be achieved, particularly at rough edges of sheet-metal workpieces or the like.

### SUMMARY OF THE INVENTION

To achieve this object, the invention proposes that the rough trimmed, punched, or outer edge of a punched hole is rounded and optionally roughened before coating. In particular, the rounding and/or roughening is done by a laser beam.

In other words, the invention is a method of preparing a sheet-metal workpiece by the steps of trimming or punching a sheet-metal workpiece to give it an edge with sharp corners, rounding the edge such that the corners are no longer sharp and merge into adjacent faces of the workpiece, and coating at least the rounded edge of the workpiece with an anticorrosive agent with a matrix of organic binders or with predominantly organic components.

Such processing of the trimmed edges of a workpiece or sheet metal, particularly by a laser beam, ensures that the edge surface of the sheet metal can be coated more uniformly with the coating because sharp edges at the trimmed edge are eliminated. According to the invention, the edge geometry is altered by laser particularly such that the trimmed edges are rounded with a radius and/or the surface roughness is increased or specific surface geometries altered such that very good adhesion of the coating is achieved. Such structuring of the trimmed or punched edges enables the coating material to also be applied to the edges in practically the same layer thickness as in the other surface regions, so that, when the parts are subsequently heated and the coating is chemically cross linked, no thickness reduction of the coating occurs at the trimmed or punched edge.

In particular, the processing is carried out by a pulsing laser beam, particularly by short-pulse laser.

As a result of the processing by laser beam, the processed material is heated. If processing is done by pulsing laser beam, particularly by short-pulse laser, the energy density, that is the heat input into the material is limited to the necessary amount, so that the workpiece is not heated in larger regions of the outer edges, but rather only in a targeted manner in the vicinity of the edges to be processed.

In addition, the trimmed edges, punched edges, or outer edges are cleaned of oxides and/or other contaminants before the rounding or roughening or synchronously therewith.

By processing with a laser beam, it is also possible to clean—that is, remove the contaminants from—the outer edges that are soiled by laser cutting or punching, for example that can have oxides or similar contaminants in the case of laser cutting, for instance. This processing of the edges can occur simultaneously with the rounding or roughening, or it can occur before or after the actual rounding or roughening.

In particular, here the cleaning is performed by processing by laser beam, preferably by pulsing laser beam.

Such contaminants on the trimmed edges that are to be eliminated are disadvantageous insofar as these areas are of higher electrical resistance during electrophoretic coating, thus resulting in a smaller coating thickness in the edge region. This is to be prevented through the cleaning performed beforehand. In particular, preferably the edge formed by rounding merges steplessly into the adjacent surface of the sheet-metal workpiece.

Also a sheet-metal workpiece with a wall thickness of less than or equal to 5 mm is used.

In addition, preferably the coating is applied in a thickness of less than or equal to 35 μm, particularly cathodic E-coatings of about 15 to 50 μm, liquid coatings up to 150 μm.

Common wall thicknesses of sheet metal can be 1.0 to 5 mm, for example. The coating thickness usually lies in the range from 20 μm to 35 μm.

In addition, the roughening is applied in the form of an irregular geometry or in the form of a regular geometry.

Such an approach not only provides a rounded, smooth edge; rather, it also enables roughening structures and the like to be applied to the trimmed edge in irregular form which result in better adhesion of the coating material and thus to a greater uniform layer thickness. This is possible both with irregular roughening geometries and with regular roughening geometries.

### BRIEF DESCRIPTION OF THE DRAWING

The above and other objects, features, and advantages will become more readily apparent from the following description, reference being made to the accompanying drawing in which:

FIG. 1 is a sectional view of an outer edge of a sheet-metal workpiece according to the invention;

FIGS. 2 and 3 show alternative forms of the outer edge after appropriate processing.

FIG. 4 shows and explains the prior art;

FIGS. 5A, 5B, and 5C are a small-scale schematic views illustrating the method of the invention.

### SPECIFIC DESCRIPTION OF THE INVENTION

In FIG. 4, one can see the sharp outer edge of a punched or trimmed sheet-metal workpiece 1. The outer edge is shown at 2. If a cathodic E-coating 3 is applied to such a finished workpiece 1, then a configuration is produced after subsequent processing in a furnace (heating to about 180 to 190° C.) such that, as a result of the surface tension due to the molecular forces of the coating, the region 4 on the edge of the workpiece 1 gets insufficient coating. Such a thin coating at an edge can result from other physical effects as well. The invention is intended to prevent this effect.

FIG. 5 shows the method of this invention. First, as shown in FIG. 5, an edge piece 1 is trimmed off the workpiece leaving a square edge 2 (FIG. 4) with two sharp corners 4. Then as shown in FIG. 5B, a laser 9 is aimed at the corners 4 to round the edge into a part-cylindrical shape 5 so they are no longer sharp and merge smoothly into the adjacent planar faces of the workpiece 2. Finally the entire workpiece 1 and in particular the edge region that was rounded in FIG. 5B are electrophoretically coated by applying a negative or positive charge to the workpiece from a power supply 11 and an opposite charge to a spray head 10 emitting charged particles of a coating material that stick to the oppositely charged workpiece 1 and form a smooth coating 3 of uniform thickness thereon, including the entire rounded edge.

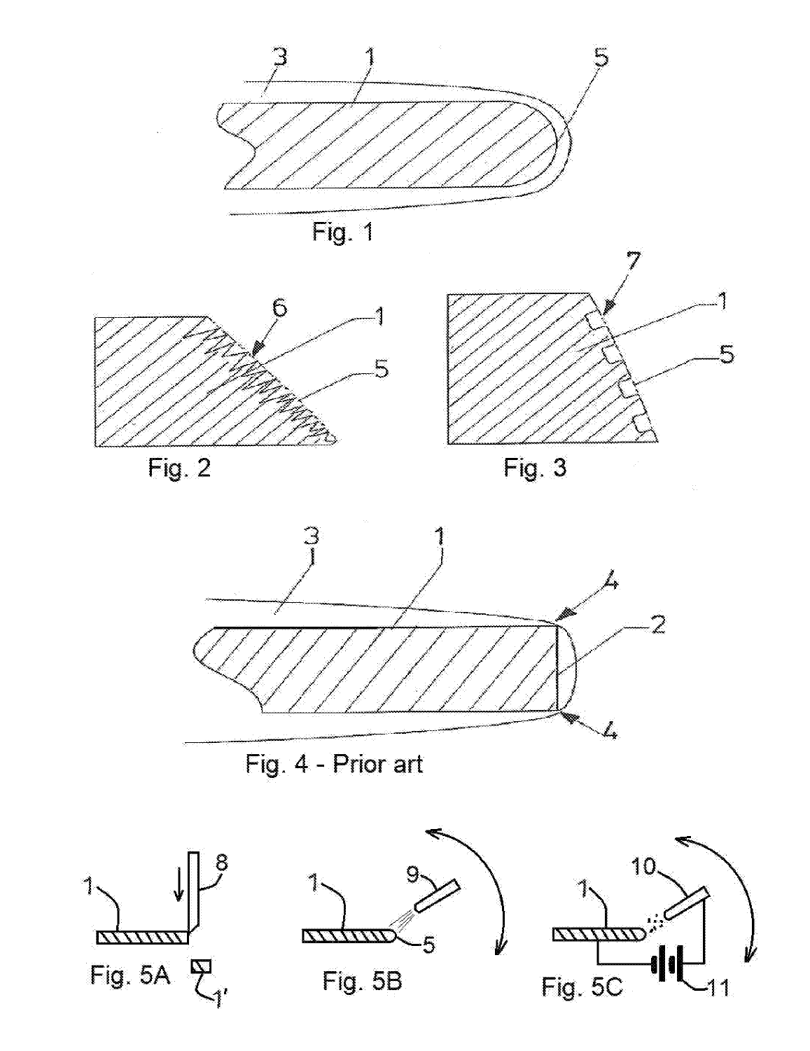

To this end, the invention proposes a method of the following type. In order to prepare a sheet-metal workpiece 1, which actually cut as shown in FIG. 5A has a trimmed edge as shown in FIG. 4, for coating with an anticorrosive agent 3 in the form of a matrix of organic binder or predominantly organic components, particularly in the form of a cathodic E-coating, the trimmed edge 2 of the workpiece 1 is rounded. The rounding structure 5 is illustrated in FIGS. 1 and 5B. Instead of the rounding structure or in addition to the rounding structure, a slightly roughened structure 6 with an irregular geometry or a roughening structure 7 with a regular geometry can be applied. The rounding and/or the roughening 5, 6, 7 is performed by a laser beam. In particular, the processing is performed here by a pulsing laser beam, particularly by short-pulse laser. In this way, unnecessarily high energy input into the workpiece 1 is avoided. What is more, the treatment with the laser beam enables any contaminants on the trimmed edge 2 to be removed simultaneously or beforehand or afterward.

Preferably, the rounded edge 5 merges steplessly into the adjacent surface of the sheet-metal workpiece, as can be seen particularly well in FIGS. 1, 5B, and 5C. Such a sheet-metal workpiece 1 usually and preferably has a wall thickness of 1 mm to 5 mm. The coating 3 preferably has a thickness of 20 to 35 μm.

What is achieved by the rounding 5 and/or by the roughening with the roughening structures 6 or 7 is that the coating material 3 can also be applied to the edge region with a sufficient layer thickness, with the maintaining of the layer thickness in the edge region also being ensured through the appropriate configuration and application of the method, so that the finished workpiece is insensitive to edge corrosion.

The invention is not limited to the illustrated embodiments, but rather can be varied in many respects within the framework of the disclosure.

All of the individual and combined features disclosed in the description and/or drawing are regarded as essential to the invention.

We claim:

1. A method of preparing a sheet-metal workpiece for a coating, the method comprising the steps of:
trimming or punching a sheet-metal workpiece to give it an edge with sharp corners;
rounding the edge such that the corners are no longer sharp and merge into adjacent faces of the workpiece; and
coating at least the rounded edge of the workpiece with an anticorrosive agent with a matrix of organic binders or with predominantly organic components.

2. The method defined in claim 1, further comprising after rounding the edge the step of:
roughening the rounded edge to improve adherence of the coating.

3. The method defined in claim 1, wherein the rounding is done by a laser beam.

4. The method defined in claim 1, wherein the laser beam is pulsed by a short-pulse laser.

5. The method defined in claim 1, further comprising the step, after the trimming or punching, of:
cleaning the edge of oxides or other contaminants before the rounding or synchronously therewith.

6. The method defined in claim 5, wherein the cleaning is done by a laser beam.

7. The method defined in claim 1, wherein the edge is rounded so as to merge steplessly into adjacent faces of the sheet-metal workpiece.

8. The method defined in claim 1, wherein the sheet-metal workpiece has a wall thickness of less than or equal to 5 mm.

9. The method defined in claim 1, wherein the coating is applied in a thickness of less than or equal to 35 μm.

10. The method defined in claim 1, further comprising the step of:
roughening the rounded edge in the form of an irregular or regular geometry.
